(19) United States
(12) Patent Application Publication
(10) Pub. No.: US 2009/0181703 A1
(43) Pub. Date: Jul. 16, 2009

(54) Method and Apparatus for Triggering Status Report in a Wireless Communications System

(76) Inventor: Sam Shiaw-Shiang Jiang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/185,123

(22) Filed: Aug. 4, 2008

Related U.S. Application Data
(60) Provisional application No. 61/020,150, filed on Jan. 10, 2008.

(51) Int. Cl. H04Q 7/20

(52) U.S. Cl. 455/466

(57) ABSTRACT

A method for triggering status report in a receiver of a wireless communications system includes sending a first status report indicating a negative acknowledgment of a packet to a transmitter and starting a status prohibit timer for prohibit sending another status report, and triggering a second status report when the packet is not completely received after the status prohibit timer expires.

### CROSS REFERENCE TO RELATED APPLICATIONS

This application claims the benefit of U.S. Provisional Application No. 61/020,1 50, filed on Jan. 10, 2008 and entitled “Packet loss detection in a wireless communications system”, the contents of which are incorporated herein by reference.

### BACKGROUND OF THE INVENTION

1. Field of the Invention

The present invention relates to a method and apparatus for triggering status report in a wireless communications system, and more particularly, to a method and apparatus for timely sending the status report to reduce the delay of status report and enhance transmission efficiency in a receiver of the wireless communications system.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates.

The access stratum of the 3G mobile telecommunications system comprises a radio resource control (RRC), radio link control (RLC), media access control (MAC), packet data convergence protocol (PDCP), broadcast/multicast control (BMC) and other sub-layers of different functions. The operations of the above-mentioned sub-layers are well known for those skilled in the art, and will not be further mentioned. Besides, the 3G mobile telecommunications system can provide different levels of transmission quality and operate in different modes according to the different requirements, for instance, Transparent Mode (TM), Unacknowledged Mode (UM), Acknowledged Mode (AM). TM is used for services requiring instant transmission, UM is used for services requiring instant transmission as well as packet orders, and AM is used for robust services requiring data accuracy but not instant transmission.

In AM, for better data accuracy and robustness, RLC layers of a transmitter and a receiver can timely initiate a STATUS report procedure to have the transmitter poll the receiver so that the receiver transmits a STATUS report unit, or a piggybacked STATUS report unit to the transmitter. According to the related protocol specification in the prior art, the RLC entity of the receiver can initiate STATUS reporting when detecting reception failure of an RLC data PDU. That is, when a timer T_reordering, which is used to detect loss of RLC PDUs at lower layer, expires, the receiving side of the AM RLC entity shall trigger a STATUS report.

Therefore, when the timer T_reordering expires, the RLC entity detects loss of RLC PDUs, and triggers a STATUS report accordingly. However, there may be problems in the prior art. First, when a data PDU is negatively acknowledged in a STATUS report, a status prohibit timer Timer_Status_Prohibit, which is meant to prohibit the receiver from sending consecutive acknowledgement STATUS reports, may be started. Then, before the status prohibit timer Timer_Status_Prohibit expires, if there is no T_reordering started, and if retransmission of the data PDU fails, the prior art does not trigger a STATUS report. Therefore, the STATUS report to negatively acknowledge the data PDU is delayed.

Besides, when all NACKs (Negative Acknowledgements) in a previous STATUS report have been successfully received by their retransmission, the prior art still prohibits transmission of a new STATUS report, and thus delays the transmission of the new STATUS report.

### SUMMARY OF THE INVENTION

According to the claimed invention, a method for triggering status report in a receiver of a wireless communications system comprises sending a first status report indicating a negative acknowledgment of a packet to a transmitter and starting a status prohibit timer for prohibit sending another status report, and triggering a second status report when the packet is not completely received after the status prohibit timer expires.

According to the claimed invention, a communications device for accurately triggering status report in a wireless communications system comprises a control circuit for realizing functions of the communications device, a processor installed in the control circuit, for executing a program code to command the control circuit, and a memory installed in the control circuit and coupled to the processor for storing the program code. The program code comprises sending a first status report indicating a negative acknowledgment of a packet to a transmitter and starting a status prohibit timer for prohibit sending another status report, and triggering a second status report when the packet is not completely received after the status prohibit timer expires.

According to the claimed invention, a method for triggering status report in a receiver of a wireless communications system comprises sending a first status report indicating negative acknowledgments of a plurality of packets to a transmitter and starting a status prohibit timer for prohibit sending another status report, and stopping the status prohibit timer when the plurality of packets are successfully received.

According to the claimed invention, a communications device for accurately triggering status report in a wireless communications system comprises a control circuit for realizing functions of the communications device, a processor installed in the control circuit, for executing a program code to command the control circuit, and a memory installed in the control circuit and coupled to the processor for storing the program code. The program code comprises sending a first status report indicating negative acknowledgments of a plurality of packets to a transmitter and starting a status prohibit timer for prohibit sending another status report, and stopping the status prohibit timer when the plurality of packets are successfully received.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of program code of FIG. 2.

FIG. 4 and FIG. 5 are flowcharts of processes according to embodiments of the present invention.

### DETAILED DESCRIPTION

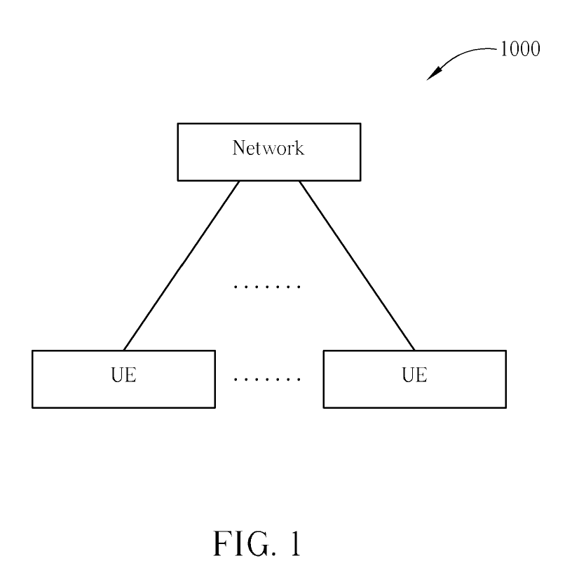

Please refer to FIG. 1, which illustrates a schematic diagram of a wireless communications system 1000. The wireless communications system 1000 can be a 3G mobile telecommunications system, an LTE (long-term evolution) system or other mobile communications systems, and is briefly composed of a network and a plurality of UEs. In FIG. 1, the network and the UEs are simply utilized for illustrating the structure of the wireless communications system 1000. Practically, the network may comprise a plurality of base stations (Node Bs), radio network controllers and so on according to actual demands, and the UEs can be devices such as mobile phones, computer systems, etc. Besides, the network and a UE can be determined as a transmitter or receiver based on the signaling direction. For example, when performing downlink transmission, the network is a transmitter and the UE is a receiver. When performing uplink transmission, the network is a receiver and the UE is a transmitter.

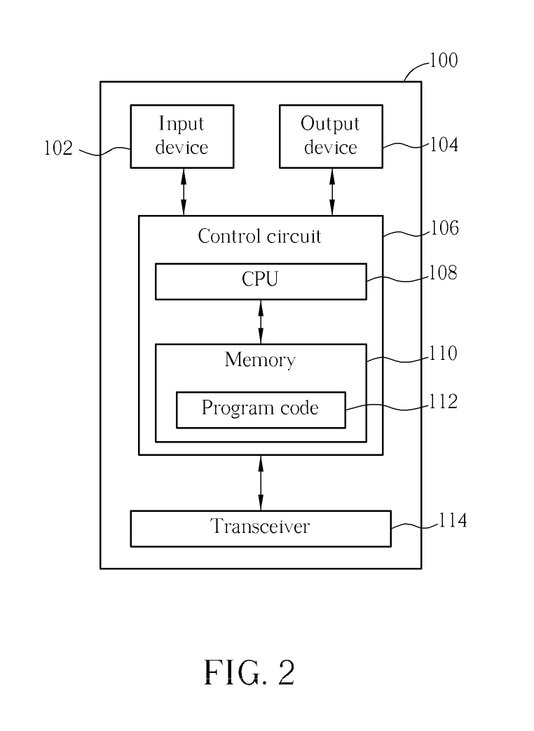

Please refer to FIG. 2, which is a functional block diagram of a communications device 100. The communications device 100 is utilized for realizing the network or the UEs. For the sake of brevity, FIG. 2 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

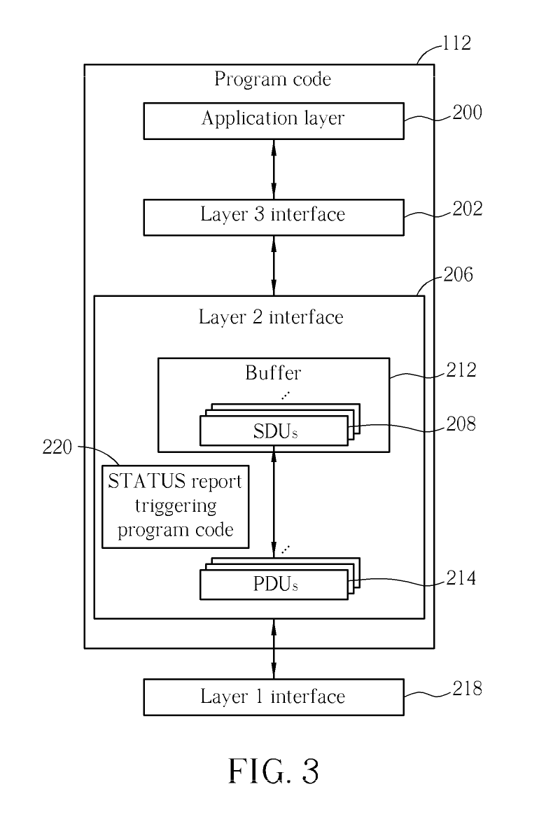

Please continue to refer to FIG. 3. FIG. 3 is a diagram of the program code 112 shown in FIG. 2. The program code 11 2 comprises an application layer 200, a Layer 3 interface 202, and a Layer 2 interface 206, and is coupled to a Layer 1 interface 218. When a signal is transmitted, the Layer 2 interface 206 forms a plurality of SDUs 208 according to data submitted by the Layer 3 interface 202, and stores the plurality of SDUs 208 in a buffer 212. Then, based on the SDUs 208 stored in the buffer 212, the Layer 2 interface 206 generates a plurality of PDUs 214, and sends the plurality of PDUs 214 to a destination terminal through the Layer 1 interface 218. In contrast, when a wireless signal is received, the signal is received through the Layer 1 interface 218, then delivered as PDUs 214 to the Layer 2 interface 206. The Layer 2 interface 206 restores the PDUs 214 to SDUs 208 and stores the SDUs 208 in the buffer 212. Last, the Layer 2 interface 206 delivers the SDUs 208 stored in the buffer 212 to the Layer 3 interface 202.

When the communications device 100 operates in AM, for better data accuracy and robustness, the Layer 2 interface 206 (RLC layer) of a transmitter and a receiver can timely initiate a STATUS report procedure to have the transmitter poll the receiver so that the receiver transmits a STATUS report unit, or a piggybacked STATUS report unit to the transmitter. In such a situation, the embodiment of the present invention provides a STATUS report triggering program code 220, for accurately triggering STATUS report.

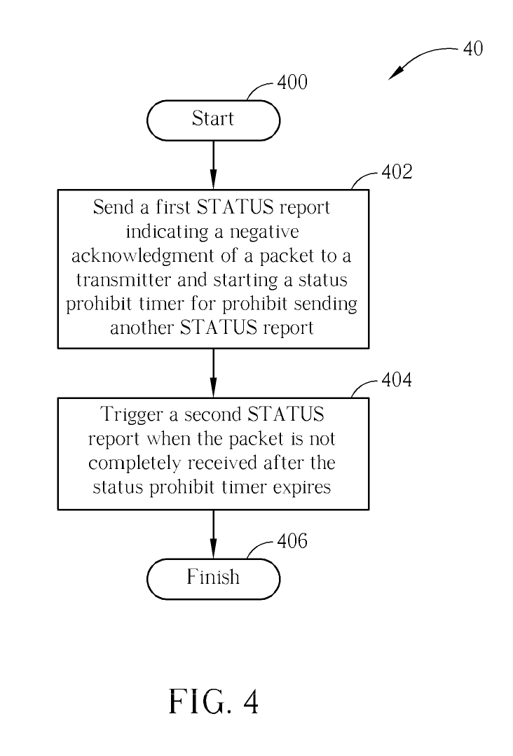

Please refer to FIG. 4, which illustrates a diagram of a process 40 according to an embodiment of the present invention. The process 40 is utilized for triggering STATUS report in a receiver of the wireless communications system 1000, and can be compiled into the STATUS report triggering program code 220. The process 40 comprises the following steps:

Step 400: Start.

Step 402: Send a first STATUS report indicating a negative acknowledgment of a packet to a transmitter and starting a status prohibit timer for prohibit sending another STATUS report.

Step 404: Trigger a second STATUS report when the packet is not completely received after the status prohibit timer expires.

Step 406: Finish.

According to the process 40, when a packet is not successfully received, the receiver triggers and sends a first STATUS report indicating negative acknowledgment of the packet, and starts a status prohibit timer (Timer_Status_Prohibit) for prohibit sending another STATUS report. After the status prohibit timer expires, if the packet is not completely received, i.e. a first packet carrying a segment of the packet is not received, the embodiment of the present invention triggers a second STATUS report, and preferably sends the second STATUS report to the transmitter to indicate the negative acknowledgment of the packet. As a result, the transmitter can retransmit the packet according to the second STATUS report.

Therefore, via the process 40, after the status prohibit timer expires, if a packet negatively acknowledged in a previous STATUS report is not completely received, the embodiment of the present invention can trigger another STATUS report indicating NACK of the packet. In other words, the receiver can timely trigger a STATUS report to negatively acknowledge the packet, so as to request retransmission of the packet. Therefore, in the embodiment of the present invention, the STATUS report can be sent promptly to reduce the delay of STATUS report in the prior art.

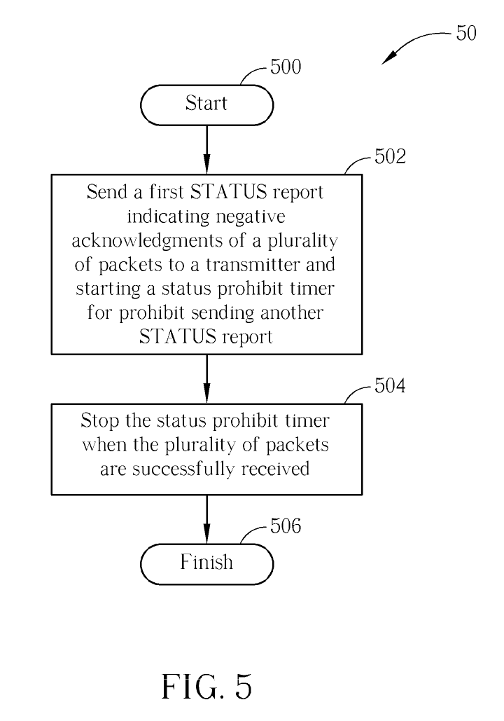

Please refer to FIG. 5, which illustrates a diagram of a process 50 according to an embodiment of the present invention. The process 50 is utilized for triggering STATUS report in a receiver of the wireless communications system 1000, and can be compiled into the STATUS report triggering program code 220. The process 50 comprises the following steps:

Step 500: Start.

Step 502: Send a first STATUS report indicating negative acknowledgments of a plurality of packets to a transmitter and starting a status prohibit timer for prohibit sending another STATUS report.

Step 504: Stop the status prohibit timer when the plurality of packets are successfully received.

Step 506: Finish.

According to the process 50, when a plurality of packets are not successfully received, the receiver triggers and sends a first STATUS report indicating negative acknowledgments of the packets, and starts a status prohibit timer (Timer_Status_Prohibit) for prohibit sending another STATUS report. Then, if the plurality of packets are successfully received, the embodiment of the present invention will stop the status prohibit timer. As a result, the receiver can trigger a second status report before or after the status prohibit timer is stopped, and send the second status report to the transmitter after the status prohibit timer is stopped.

Therefore, via the process 50, when all packets that are negatively acknowledged in a STATUS report have been successfully received, the embodiment of the present invention stops the status prohibit timer, so that a new STATUS report, if triggered, can be transmitted after the status prohibit timer is stopped. Therefore, in the embodiment of the present invention, the STATUS report can be sent promptly to reduce the delay of STATUS report in the prior art.

In summary, the embodiment of the present invention can timely send the STATUS report to reduce the delay of STATUS report and enhance transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for triggering status report in a receiver of a wireless communications system comprising:
sending a first status report indicating a negative acknowledgment of a packet to a transmitter and starting a status prohibit timer for prohibit sending another status report; and
triggering a second status report when the packet is not completely received after the status prohibit timer expires.

2. The method of claim 1 further comprising sending the second status report to the transmitter.

3. The method of claim 1, wherein the packet is determined to be not completely received when a first packet carrying a segment of the packet is not received.

4. A communications device for accurately triggering status report in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending a first status report indicating a negative acknowledgment of a packet to a transmitter and starting a status prohibit timer for prohibit sending another status report; and
triggering a second status report when the packet is not completely received after the status prohibit timer expires.

5. The communications device of claim 4, wherein the program code further comprises sending the second status report to the transmitter.

6. The communications device of claim 4, wherein in the program code, the packet is determined to be not completely received when a first packet carrying a segment of the packet is not received.

7. A method for triggering status report in a receiver of a wireless communications system comprising:
sending a first status report indicating negative acknowledgments of a plurality of packets to a transmitter and starting a status prohibit timer for prohibit sending another status report; and
stopping the status prohibit timer when the plurality of packets are successfully received.

8. The method of claim 7 further comprising triggering a second status report before the status prohibit timer is stopped, and sending the second status report to the transmitter after the status prohibit timer is stopped.

9. The method of claim 7 further comprising triggering and sending a second status report to the transmitter after the status prohibit timer is stopped.

10. A communications device for accurately triggering status report in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending a first status report indicating negative acknowledgments of a plurality of packets to a transmitter and starting a status prohibit timer for prohibit sending another status report; and
stopping the status prohibit timer when the plurality of packets are successfully received.

11. The communications device of claim 10, wherein the program code further comprises triggering a second status report before the status prohibit timer is stopped, and sending the second status report to the transmitter after the status prohibit timer is stopped.

12. The communications device of claim 10, wherein the program code further comprises triggering and sending a second status report to the transmitter after the status prohibit timer is stopped.
